(19) United States
(12) Patent Application Publication
(10) Pub. No.: US 2004/0045794 A1
(43) Pub. Date: Mar. 11, 2004

(54) Conveyor assembly for affixing booklets to a moving web

(76) Inventors: Paul J. Connelly, Aurora (CA); Steve C. Painter, Ajax (CA)

Correspondence Address: DOWELL & DOWELL PC, SUITE 309, 1215 JEFFERSON DAVIS HIGHWAY, ARLINGTON, VA, 22202

(21) Appl. No.: 10/236,901

(22) Filed: Sep. 9, 2002

(51) Int. Cl. B65G 19/26

(52) U.S. Cl. 198/732

(57) ABSTRACT

The conveyor assembly of the present invention is for affixing booklets and the like to a moving web. The conveyor assembly includes a pair of endless chain each having a plurality of lugs attached thereto, a pair of lug supports and a pair of booklet supports. The plurality of lugs are pivotally attached to the each endless chain. Each lug has an elongate pushing arm and a support arm. Each lug is movable from a pushing position to a retracted position. The pair of lug support are spaced apart and generally parallel and are for supporting the support arm of the lugs. The pair of booklet support are spaced apart and generally parallel and are spaced above a respective lug support.

### FIELD OF THE INVENTION

This invention relates to conveyor assemblies and in particular conveyor assemblies which are used to affix booklets or other attachments to a moving web.

### BACKGROUND OF THE INVENTION

Conveyor assemblies are well known. Similarly conveyor assemblies used to affix booklets or other attachments to a moving web are well known. They are used in association with a wide variety of industries. For example they may be used to affix a booklet of information to a pharmaceutical product. Alternatively they may be used to affix a promotional item to a CD or computer disc. Alternatively they may be used to affix a recipe booklet to a food product or product label.

One current method of accurately affixing booklets to a moving web is to feed the booklets from a friction feeder into a lug conveyor which has pusher lugs evenly spaced around the length of a chain. As the booklets are being pushed by the lugs they are in a known datum position relative to the pusher and chain. Knowing the position of the booklets allows the user accurately to push them into the pinch point of the lower substrate and the upper laminate. There are typically two sets of lugs pushing the booklets one on each side of the booklet.

The current method uses lugs, which are relatively short in height, and subsequently the end sprocket is just below the carrying guide surface of the booklets. The pusher lugs are attached to the chain by means of attachments, which allow the lugs to rotate relative to the chain. The lugs are held in an upright position by the lug support, along the top segment of the chain. When the lug pushing the booklet gets to a position near the centerline of the end sprocket, the lug support stops and the lug can fall backwards or drop-off. At this point the front of the booklet must be in the bite of the pinch rollers for it to continue moving. Therefore the minimum length of the booklet that can be handled is governed by the size of the end sprocket and the size of the lower pinch roller. Accordingly with the arrangement described herein in regard to the current method, it is impossible to close the gap between the lug and the pinch point. The limitation on the size of the booklet is one of the main limiting factors of the current technique.

Another limiting factor of this technique is that it is time consuming to modify the machine to accept booklets of different lengths. Specifically when different lengths of product are being handled, the conveyor assembly has to be retracted away from the pinch roller to allow the lugs to fall away as the leading edge of the booklet enters the bite of the pinch point. Having to do this means that the whole machine has to be retractable and bridging pieces have to be provided to fill in the gap created when the conveyor is retracted.

Accordingly it would be advantageous to provide an assembly that will accommodate smaller booklets. Further it would be advantageous to provide an assembly that is easily modified to accommodate booklets of different lengths.

### SUMMARY OF THE INVENTION

The present invention is directed to a conveyor assembly for affixing booklets and the like to a moving web. The conveyor assembly includes a pair of endless chain each having a plurality of lugs attached thereto, a pair of lug supports and a pair of booklet supports. The plurality of lugs are pivotally attached to the each endless chain. Each lug has an elongate pushing arm and a support arm. Each lug is movable from a pushing position to a retracted position. The pair of lug support are spaced apart and generally parallel and are for supporting the support arm of the lugs. The pair of booklet support are spaced apart and generally parallel and are spaced above a respective lug support.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a side view of the conveyor assembly of the present invention;

FIG. 2 is a top view of the conveyor assembly;

FIG. 3 is an enlarged perspective view of the endless fixed pitch transmission chain of the attachment conveyor portion of the conveyor assembly, the chain having two lugs attached thereto;

FIG. 4 is an enlarged side view of a portion of the attachment conveyor portion and the pinch rollers of the conveyor assembly;

FIG. 5 is an enlarged top view of the lug support of the attachment conveyor portion of the conveyor assembly;

FIG. 6 is an enlarged sectional view of the lug support of the attachment conveyor portion of the conveyor assembly; and

FIG. 7 is a prior art conveyor assembly.

### DETAILED DESCRIPTION OF THE INVENTION

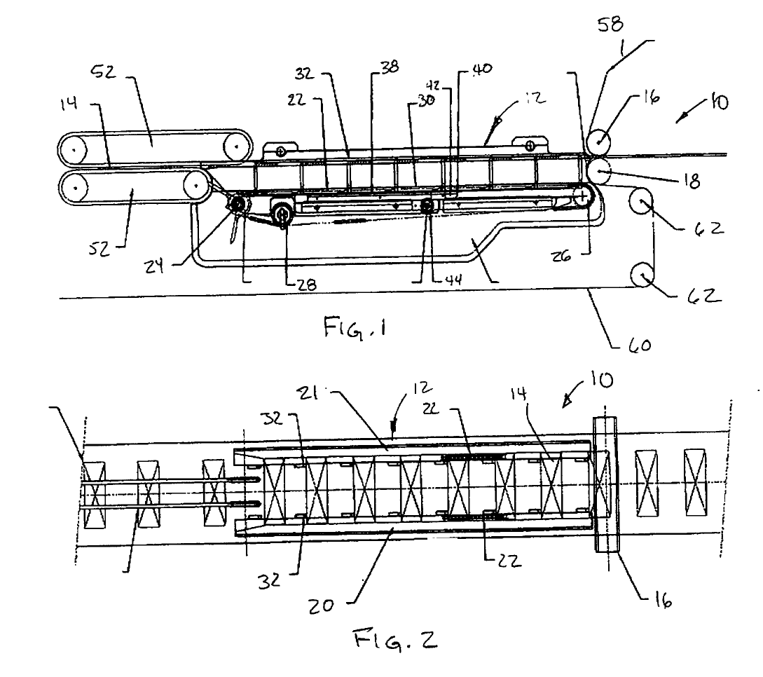

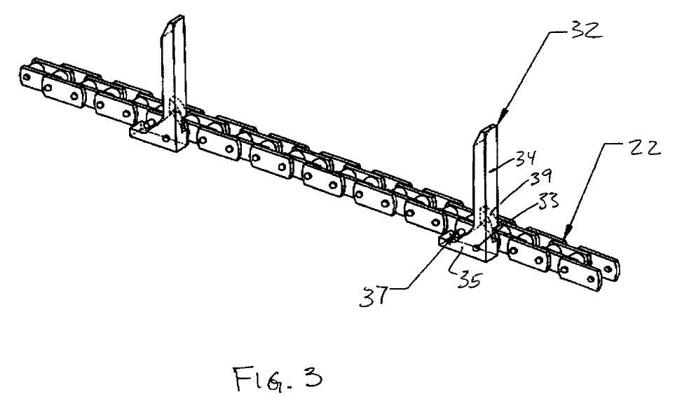

Referring to FIG. 1, the conveyor assembly of the present invention is shown generally at 10. The conveyor assembly includes an attachment conveyor portion 12 which feeds booklets 14 into upper 16 and lower 18 pinch rollers.

The attachment conveyor portion 12 includes a right hand portion 20 and a left hand portion 21. Where only one portion is shown and described it will be the left hand portion, but it will be appreciated by those skilled in the art that the right hand portion is a mirror image of the right hand portion. The attachment conveyor portion 12 includes an endless fixed pitch transmission chain 22 between a drive sprocket 24 and an idler sprocket 26. A tension sprocket 28 serves to keep the transmission chain 22 taut. Transmission chain 22 is held in place by groove 31 in guide 30 as best seen in FIG. 6.

A plurality of lugs 32 are evenly spaced around transmission chain 22 at predetermined intervals as best seen in FIG. 3. Lugs 32 each have an elongate pushing arm 34 and a support arm 35. The elongate pushing arm 34 which extends upwardly when the lug 32 is in the pushing orientation. Lugs 32 are attached to the inside of chain 22 at pivot point 33. In the pushing position support arm 35 rests between a post 37 that extends outwardly from chain 22 and the lug support 36. Elongate pushing arm 34 is provided with a post groove 39 so that when lug 32 drops off post 37 does not inhibit the drop off motion of lug 32 and lug 32 can moving from a pushing position to a retracted position.

A lug support 36 provides a platform for lugs 32 to travel along as they go through the cycle. Preferably lug support includes a fixed lug support 38 and an adjustable lug support 40. Adjustable lug support 40 includes a gear rack 42 which meshes with a gear 44. Gear 44 is mounted on a splined bushing 46 which engages to a cross splined shaft 48. At the end of the shaft 48 is an adjustment knob 50. At a point approximately half way along the attachment conveyor assembly 12 the fixed lug support 38 stops, and thereafter the lug 32 is held in a vertical position by the adjustable lug support 40. The joint between the fixed lug support 38 and the adjustable lug support 40 is along the centerline of the lug 32. When the knob 50 is rotated the gear 44 rotates, which in turn adjusts the linear position of the adjustable lug support 40. The position of the adjustable lug support 40 dictates where each lug 32 drops away from the booklet 14. For small booklets the lug 32 will drop away relatively close to the upper 16 and lower 18 pinch rollers, whereas for larger booklets lug 32 will drop away further away.

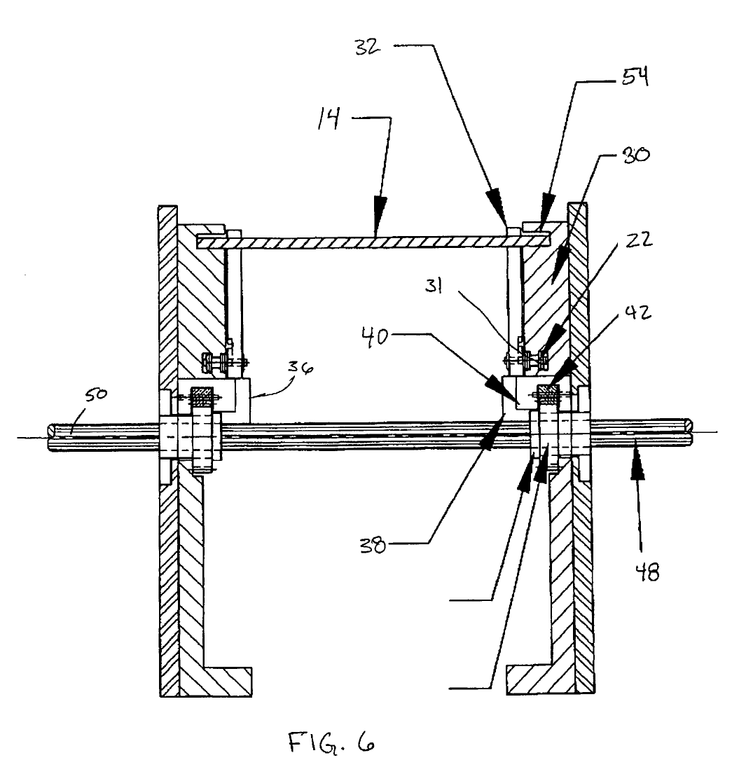

The axis of the idle sprocket 26 is positioned below and slightly offset from the axis of the lower pinch roller 18. As can be seen in FIGS. 5 and 6, the lug 32 can push a very small booklet 14 or other attachment. Lower substrate guide rollers 62 are provided to direct the lower substrate 60 so that it does not interfere with the attachment conveyor portion 12. A friction feeder 54 or other type of system provides the booklets 14 to the attachment conveyor portion 12.

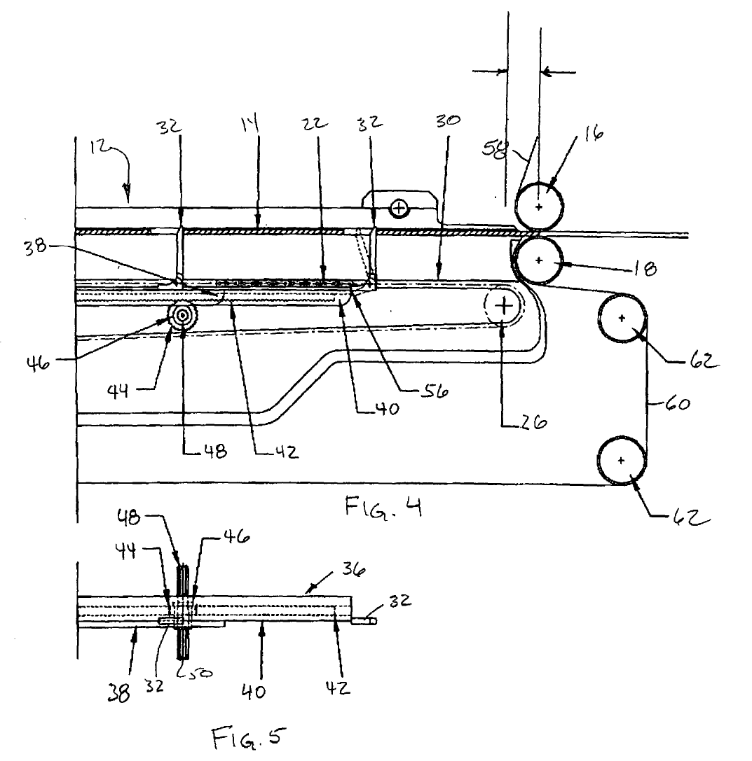

In use booklets 14 are provided to attachment conveyor assembly 12 by way of a friction feeder 54 or other suitable means. The booklets 14 are then pushed by lug 32 and are supported by booklet grooves 54 in guide 30. Thereby booklet grooves 54 serve as booklet supports and are spaced above the lug support 36. Lugs 32 move along lug support 36 until lugs reach drop off point 56, best seen in FIG. 4. At the drop off point 56 movement of the lug 32 from the pushing position to the retracted position is initiated. Drop off point 56 is adjusted so that the booklet is easily fed into upper 16 and lower 18 pinch rollers. A top substrate 58 is fed over upper pinch rollers. A lower substrate 60 is fed around lower pinch roller 18 and further around lower substrate rollers 62 such that lower substrate does not interfere with attachment conveyor assembly 12.

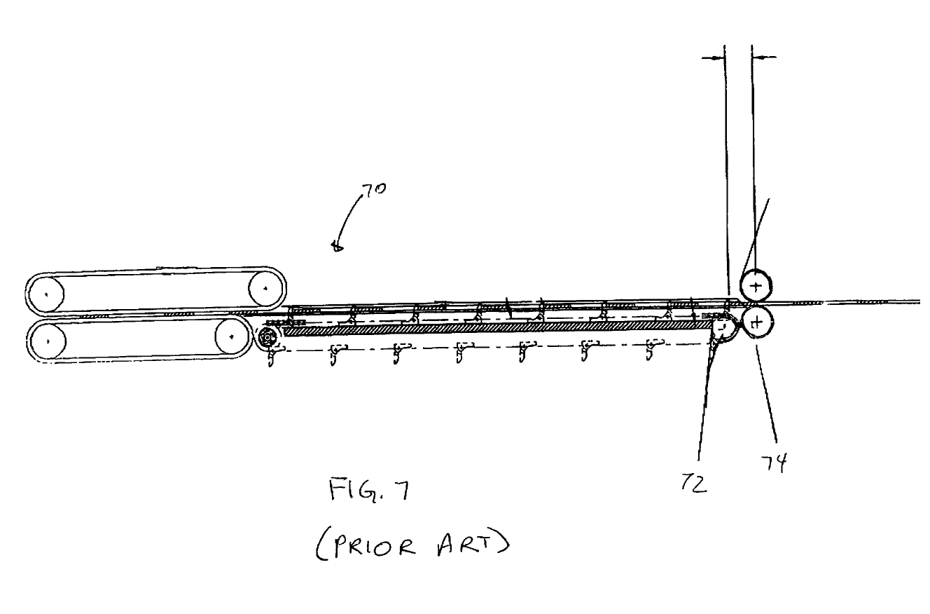

It will be appreciated by those skilled in the art that the conveyor assembly 10 of the present invention allows the user to affix much smaller booklets to a substrate than allowed with the prior art conveyor assemblies an example of which is shown in FIG. 7 at 70. The length of the allowable length of the booklet is limited by the position of the idler sprocket 72 relative to the lower pinch roller 74. These are brought as close together as practicable but the allowable length of the booklet is essentially the sum of the radius of the idler sprocket 72 and the lower pinch roller 74. In contrast the conveyor assembly 10 of the present invention allows for much smaller booklets or other attachments. The pusher arm 34 of lugs 32 is longer such that the idler sprocket 26 herein is positioned lower than the lower pinch roller 18 such that lug 32 can all but touch lower pinch roller 18 if desired. Further the conveyor assembly 10 of the present invention has the further advantage of the providing an adjustable lug support 40 which allows for adjustment of the drop off point 56 of pusher arm 34. Thus conveyor assembly 10 of the present invention can easily be adjusted to accommodate different sized attachments.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

What is claimed as the invention is:

1. A conveyor assembly for affixing booklets to a moving web comprising:
a pair of spaced apart generally parallel endless chains;
a plurality of lugs pivotally attached to each of the pair of endless chains, each lug having an elongate pushing arm and a support arm and each lug being movable from a pushing position to a retracted position;
a pair of spaced apart generally parallel lug support for supporting the support arm of the lugs; and
a pair of spaced apart generally parallel booklet support each spaced above a respective lug support.

2. A conveyor assembly as claimed in claim 1 wherein the lugs are evenly spaced around each endless chain.

3. A conveyor assembly as claimed in claim 2 wherein each lug support includes a fixed portion and a movable portion, wherein the distal end of the movable portion defines a drop off point for the lugs and whereby movement of the movable portion adjusts the drop off point for the lugs wherein the lugs initiate movement from the pushing position to the retracted position.

4. A conveyor assembly as claimed In claim 3 wherein each movable portion of the lug support includes a gear operably engaged to a gear rack and a shaft connecting the respective movable portions whereby rotation of the shaft adjusts the drop off point of each movable portion.

5. A conveyor assembly as claimed in claim 4 further including a plurality of posts extending outwardly from the chain whereby in the pushing position each support arm of the lug is between the lug support and the post and wherein each elongate pushing arm further includes a post groove and wherein the post moves through the post groove as the lug moves from the pushing position to the retracted position.

6. A conveyor assembly as claimed in claim 5 further including a drive sprocket, an idler sprocket and a tension sprocket and wherein the endless chain is positioned therearound.

7. A conveyor assembly as claimed in claim 6 further including an upper pinch roller and a lower pinch roller and the booklet moves from the booklet support to the upper pinch roller and the lower pinch roller and wherein the idler sprocket is adjacent to the lower pinch roller and the center line of the idler sprocket is below the center line of the lower pinch roller.

8. A conveyor assembly as claimed in claim 1 wherein each lug support includes a fixed portion and a movable portion, wherein the distal end of the movable portion defines a drop off point for the lugs and whereby movement of the movable portion adjusts the drop off point for the lugs wherein the lugs initiate movement from the pushing position to the retracted position.

9. A conveyor assembly as claimed in claim 8 wherein each movable portion of the lug support includes a gear operably engaged to a gear rack and a shaft connecting the respective movable portions whereby rotation of the shaft adjusts the drop off point of each movable portion.

10. A conveyor assembly as claimed in claim 9 further including a plurality of posts extending outwardly from the chain whereby in the pushing position each support arm of the lug is between the lug support and the post and wherein each elongate pushing arm further includes a post groove and wherein the post moves through the post groove as the lug moves from the pushing position to the retracted position.

11. A conveyor assembly as claimed in claim 10 further including a drive sprocket, an idler sprocket and a tension sprocket and wherein the endless chain is positioned therearound.

12. A conveyor assembly as claimed in claim 11 further including an upper pinch roller and a lower pinch roller and the booklet moves from the booklet support to the upper pinch roller and the lower pinch roller and wherein the idler sprocket is adjacent to the lower pinch roller and the center line of the idler sprocket is below the center line of the lower pinch roller.

13. A conveyor assembly as claimed in claim 1 further including a plurality of posts extending outwardly from the chain whereby in the pushing position each support arm of the lug is between the lug support and the post and wherein each elongate pushing arm further includes a post groove and wherein the post moves through the post groove as the lug moves from the pushing position to the retracted position.

14. A conveyor assembly as claimed in claim 13 further including a drive sprocket, an idler sprocket and a tension sprocket and wherein the endless chain is positioned therearound.

15. A conveyor assembly as claimed in claim 14 further including an upper pinch roller and a lower pinch roller and the booklet moves from the booklet support to the upper pinch roller and the lower pinch roller and wherein the idler sprocket is adjacent to the lower pinch roller and the center line of the idler sprocket is below the center line of the lower pinch roller.

16. A conveyor assembly as claimed in claim 1 further including a drive sprocket, an idler sprocket and a tension sprocket and wherein the endless chain is positioned therearound.

17. A conveyor assembly as claimed in claim 16 further including an upper pinch roller and a lower pinch roller and the booklet moves from the booklet support to the upper pinch roller and the lower pinch roller and wherein the idler sprocket is adjacent to the lower pinch roller and the center line of the idler sprocket is below the center line of the lower pinch roller.
